(19) United States
(12) Patent Application Publication
(10) Pub. No.: US 2006/0011411 A1
(43) Pub. Date: Jan. 19, 2006

(54) Acoustic compressor

(75) Inventors: Masaaki Kawahashi, Saitama-shi (JP); Tamotsu Fujioka, Yokohama-shi (JP); Masayuki Saito, Cincinnati, OH (US)

Correspondence Address: ZARLEY LAW FIRM P.L.C., CAPITAL SQUARE, 400 LOCUST, SUITE 200, DES MOINES, IA, 50309-2350, US

(73) Assignee: Anest Iwata Corporation, Yokohama-shi (JP)

(21) Appl. No.: 10/891,790

(22) Filed: Jul. 15, 2004

(51) Int. Cl. F02K 1/00; F01N 1/14; F02K 1/28; F02K 1/38; F02K 1/46

(52) U.S. Cl. 181/262; 181/259; 181/220

(57) ABSTRACT

An acoustic compressor has an acoustic resonator and a piston reciprocated by an actuator at a base of the acoustic resonator. A valve device is provided on the upper end of the acoustic resonator. The valve device comprises a suction chamber and a discharger chamber. External air is fed through an inlet to the suction chamber and sucked into the acoustic resonator through the suction bore. Then, the air in the resonator is compressed by the reciprocating piston. The discharge chamber has a discharge bore and an outlet to the outside. An outward nonreturn valve is larger in valve-opening resistance than an inward nonreturn valve in the suction bore. When the air pressure in the resonator exceeds a certain value, the high-pressure air is transferred to the discharge chamber through the discharge bore by allowing the outward nonreturn valve to open and then discharged through the outlet to the outside.

### BACKGROUND OF THE INVENTION

The present invention relates to an acoustic compressor for a gas in which amplitude pressure change is utilized on the basis of acoustic resonance.

An acoustic compressor is known in which a piston is reciprocated axially with minute amplitude by an actuator in the larger-diameter base of an acoustic resonator thereby discharging a gas sucked into an acoustic resonator through the smaller-diameter end by pressure change in the acoustic resonator with reciprocation of the piston.

The acoustic compressor is constructed on the basis of amplitude pressure change of acoustic standing waves produced by resonance of a gas column in a tube involved by piston movement when the piston is reciprocated axially at minute amplitude. An operating portion is only an actuator for reciprocating the piston inside the base of an acoustic resonator. Thus, the structure is very simple and malfunction is not likely to occur. The acoustic compressor is expected to be used widely in the future.

However, in the acoustic compressor, a gas is sucked and discharged only by a piston that vibrates minutely. There is basic problem that a compression ratio obtained is small.

### SUMMARY OF THE INVENTION

In view of the disadvantage, it is an object of the present invention to provide an acoustic compressor in which high-pressure compressed gas is obtained by very simple means, the compressor being small thereby increasing its application significantly.

### BRIEF DESCRIPTION OF THE DRAWINGS

The features and advantages of the invention will become more apparent from the following description with respect to embodiments as shown in appended drawings wherein:

FIG. 1 is a vertical sectional view of an embodiment of an acoustic compressor according to the present invention; and

FIG. 2 is a vertical sectional view of another embodiment of an acoustic compressor according to the present invention.

### DETAILED DESCRIPTION OF PREFERRED EMBODIMENTS

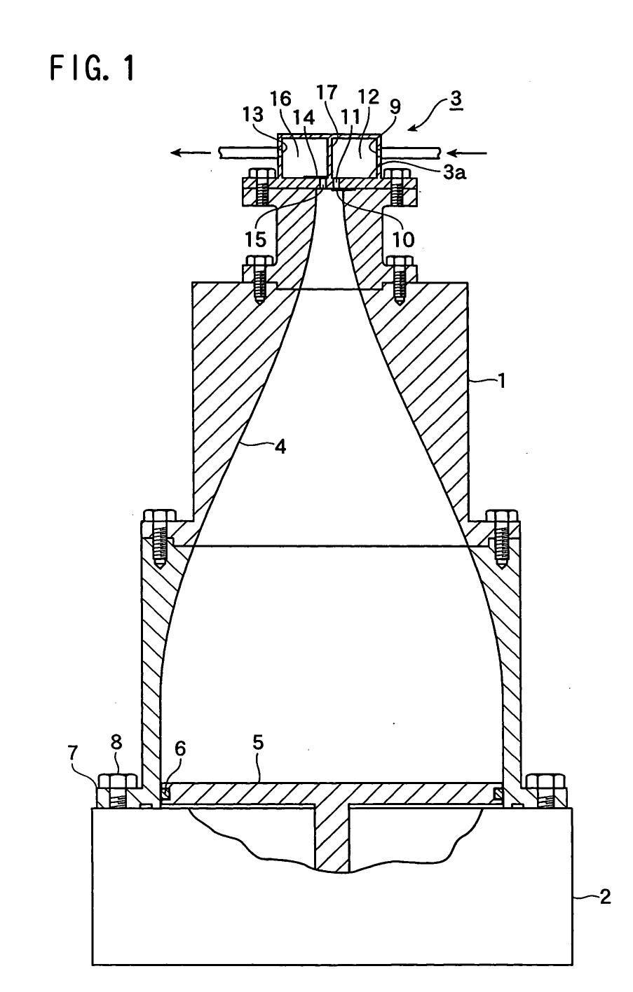

FIG. 1 is a vertical sectional front view of an embodiment of an acoustic compressor according to the present invention.

In the acoustic compressor, an actuator 2 is mounted to a larger-diameter base at the lower end of an acoustic resonator 1, and a valve 3 is mounted on the smaller-diameter upper end.

The acoustic resonator 1 has a resonant cavity 4 in which the lower end is larger and the upper end is smaller in diameter. The inner surface of the resonant cavity 4 is shown by the following formula:

$$r ( x ) = \frac{{r}_{p} - {r}_{o}}{2} cos ( \frac{π}{L} x ) + \frac{{r}_{p} + {r}_{o}}{2}$$

where L is the length of the resonant cavity, rₚ is the radius of the lower end or rₒ is the radius of the upper end for suction and discharge.

The actuator 2 functions as support and reciprocates a piston 5. The piston 5 is made of light alloy and engaged in the lower end of the resonant cavity 4. A seal member 6 is engaged in the outer circumference of the piston 5.

The acoustic resonator 1 has an outward flange 7 which is put on the upper surface of the actuator 2. The outward flange 7 is fastened to the actuator 2 with a suitable number of bolts 8.

The valve 3 comprises a suction chamber 12 which has an inlet 9 and a sucking bore 12 with an air-sucking inward nonreturn valve 10 at the lower surface of a bottom wall 3a, and a discharge chamber 16 which has a discharge bore 15 with a compressed-gas-discharging outward nonreturn valve 14 at the upper surface of the bottom wall 3a. The valve 3 is mounted on the upper end of the acoustic resonator 1.

The inward and outward nonreturn valves 10,14 comprise reed valves or rubber-plate valves made of thin steel plates secured to the lower surface of the bottom wall of the suction chamber 12 and to the upper surface of the bottom wall of the discharge chamber 16 respectively. They may be made of ball-types or others.

Opening resistant force of the outward nonreturn valve 14 is much higher than that of the inward nonreturn valve 10. The reasons will be described later.

The suction chamber 12 and the discharge chamber 16 are partitioned by a partition wall 17.

Driving frequency of the actuator 2 is controlled by a function synthesizer (not shown) with the accuracy of about 0.1 Hz.

The piston 5 is reciprocated axially at minute amplitude at the larger-diameter base of the lower end of the acoustic resonator 1. Accordingly when pressure amplitude in the acoustic resonator 1 becomes significant small value, air is sucked through the inlet 9, introduced into the suction chamber 12 and sucked into the acoustic resonator 1 through the sucking bore 11 and the inward nonreturn valve 10. Meanwhile, when pressure amplitude in the acoustic resonator 1 becomes significant large value, air is transferred from the acoustic resonator 1 and discharged from the outlet 13 of the discharge chamber 16 through the discharge bore 15 and the outward nonreturn valve 14 under pressure.

As mentioned above, in the embodiment as shown, opening resistant force in the outward nonreturn valve 14 of the discharge bore 15 is much higher than that of the inward nonreturn valve 10 in the sucking bore 11.

At the beginning of operation, air which is sucked in the resonant cavity 4 through the sucking bore 11 and the inward nonreturn valve 10 is not discharged from the discharge bore 15 directly, but is discharged through the discharge bore 15 and the outlet 13 by opening the outward nonreturn valve 14 only after pressure in the resonant cavity 4 elevates to more than a certain value.

So, before the piston 5 moves, air is introduced into the resonant cavity 4 through the inlet 9 and the sucking bore 11 of the suction chamber 12. Then, air is compressed by reciprocation of the piston 5 and discharged through the discharge bore 15 by opening the nonreturn valve 14 when pressure in the resonant cavity 4 exceeds a certain value. Thus, high-pressure air discharged through the outlet 13 is obtained.

Thus, compared with a case where the nonreturn valves 10,14 are equal to each other in opening resistant force, density of the gas sucked and discharged into the resonant cavity 4 with reciprocal motion becomes larger thereby increasing discharge pressure and amount.

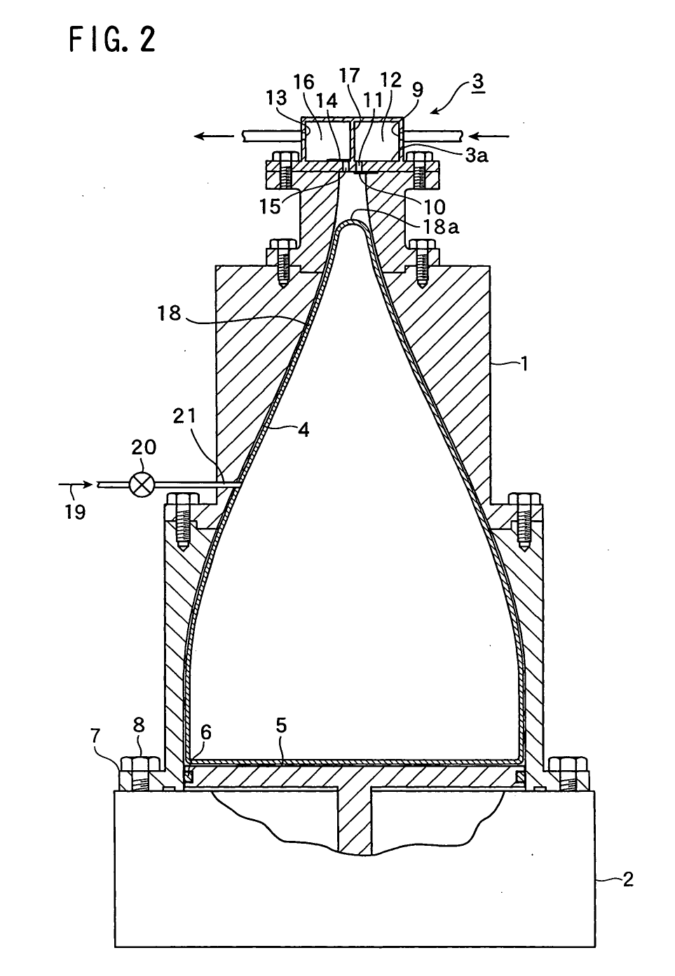

FIG. 2 is another embodiment of the present invention.

A pressurizing rubber bag 18 is put on the inner surface of a resonant cavity 4 of an acoustic resonator 1, and the upper end 18a is slightly lower than a sucking bore 11 and a discharge bore 15, and a pressurized gas 19 is fed to the pressurized bag 18 through a feeding bore 21 in the side wall of the acoustic resonator 1 via a valve 20.

The gas sucked in the resonant cavity 4 through the sucking bore 4 with reciprocal motion of a piston 5 is pressed on the upper end 18a of the pressurized bag 18 to deform at a certain amount, and with up-and-down motion of the upper end 18a, the external gas is sucked to the smaller-diameter upper end in the resonant cavity 4. After the pressure of the gas in this part exceeds a certain value, it is discharged from the discharge bore 15. The smaller-diameter upper end 18a of the pressurizing bag 18 is strongly reciprocated at a larger stroke compared with a stroke of the piston 5 and the upper inner space of a resonant cavity 4 is pressurized thereby achieving larger discharge pressure.

The foregoing merely relates to embodiments of the invention. Various changes and modifications may be made by a person skilled in the art without departing from the scope of claims wherein:

What is claimed is:

1. An acoustic compressor comprising:
an acoustic resonator;
a piston in a base of the acoustic resonator;
an actuator connected to the piston to reciprocate the piston to vibrate air in the acoustic resonator; and
a valve device at an upper end of the acoustic resonator, external air being supplied into the resonator by the valve device.

2. An acoustic compressor as claimed in claim 1 wherein the valve device comprises a suction chamber and a discharge chamber, said suction chamber has an inlet for external air and a sucking bore through which the suction chamber communicates with the acoustic resonator, said sucking bore having an inward nonreturn valve, said discharge chamber having a discharge bore through which the acoustic resonator communicates with the discharge chamber and an outlet for discharging air to outside, said discharge bore having an outward nonreturn that is larger in valve-opening resistance than said inward nonreturn valve.

3. An acoustic compressor as claimed in claim 1 wherein an pressurizing bag is provided in the acoustic resonator so that an outer surface of the bag is put on an inner surface of the acoustic resonator except a space between an upper end of the bag and a lower surface of the valve device.
